(19) United States
(12) Patent Application Publication
(10) Pub. No.: US 2009/0271231 A1
(43) Pub. Date: Oct. 29, 2009

(54) SOLUTION UTILIZING COMMODITY-ORIENTED CORRECTION GUIDELINES TO CORRECT DEFECTIVE ELECTRONIC BUSINESS TRANSACTIONS

(75) Inventor: Donald E. Buddenbaum, Raleigh, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/111,007

(22) Filed: Apr. 28, 2008

(51) Int. Cl. G06Q 90/00

(52) U.S. Cl. 705/7

(57) ABSTRACT

The present invention can include a solution for correcting defective electronic business transactions using a commodity-oriented approach. In this method, a defective electronic business transaction can be received from an automated processing system. A correction value can be calculated for the defective transaction. The calculated correction value can be compared against a preset threshold value. When indicated by the result of the comparing step, the defective electronic business transaction can be corrected.

### BACKGROUND OF THE INVENTION

The present invention relates to the field of electronic commerce, and, more particularly, to using commodity-oriented correction guidelines to correct defective electronic business transactions.

Electronic commerce and electronic data exchanges are an integral part of many businesses. Some businesses expend large quantities of time and resources to correct defects contained within received electronic business transactions. However, the processes used to correct these defects tend to focus on how to correct the defects without considering the overall value to the business for correcting the transactions.

Value concepts like return on investment can be applied to the process of correcting defective business transactions. For example, if it costs the business $100 in resources to have an employee manually correct a business transaction and the return value is $30, then this approach is obviously a drain on the company. Without incorporating business objectives into the process of correcting electronic business transactions, businesses unnecessarily waste resources.

### BRIEF SUMMARY OF THE INVENTION

The present invention can be implemented in accordance with numerous aspects consistent with the materials presented herein. One aspect of the present invention can include a method for correcting defective electronic business transactions using a commodity-oriented approach. In this method, a defective electronic business transaction can be received from an automated processing system. A correction value can be calculated for the defective transaction. The calculated correction value can be compared against a preset threshold value. When indicated by the result of the comparing step, the defective electronic business transaction can be corrected.

Another aspect of the present invention can include a system for correcting defective electronic business transactions that uses a commodity-oriented approach. Such a system can include commodity-oriented correction guidelines, correction procedures, and a transaction correction manager. The commodity-oriented correction guidelines can quantify business value factors pertaining to a defective electronic business transaction that cannot be processed to completion by an automated processing system. The correction procedures can define the correction measures required to correct the defective electronic business transaction. The transaction correction manager can be configured to automatically correct the defective electronic business transaction utilizing the commodity-oriented correction guidelines and correction procedures.

Still another aspect of the present invention can include a computer program product for correcting defective electronic business transactions in accordance with commodity-oriented correction guidelines. The computer program product can consist of a computer usable medium having computer usable program code embodied therewith. The computer usable program code can be configured to process defective electronic business transactions received from an automated processing system. Processing of the defective electronic business transactions can include calculating a correction value for the defective electronic business transaction. Another portion of the computer usable program code can be configured to determine and execute correction procedures to correct the defective electronic business transaction, based upon the calculated correction value.

### BRIEF DESCRIPTION OF THE SEVERAL VIEWS OF THE DRAWINGS

There are shown in the drawings, embodiments which are presently preferred, it being understood, however, that the invention is not limited to the precise arrangements and instrumentalities shown.

FIG. 1 is a schematic diagram illustrating a system for correcting a defective electronic business transaction using commodity-oriented correction guidelines in accordance with embodiments of the inventive arrangements disclosed herein.

FIG. 2 is a flow chart of a method describing the use of commodity-oriented correction guidelines for correcting defective business transactions in accordance with an embodiment of the inventive arrangements disclosed herein.

### DETAILED DESCRIPTION OF THE INVENTION

The present invention discloses a solution that uses commodity-oriented correction guidelines to correct defective electronic business transactions. More specifically, the value of correcting the defects of a specific electronic business transaction can be quantifiably expressed as a series of commodity-oriented correction guidelines. A transaction correction manager can utilize the commodity-oriented correction guidelines to determine if the correction of a defective business transaction is in accordance with business objectives. The transaction correction manager can then execute correction procedures to correct the defects.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including, but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

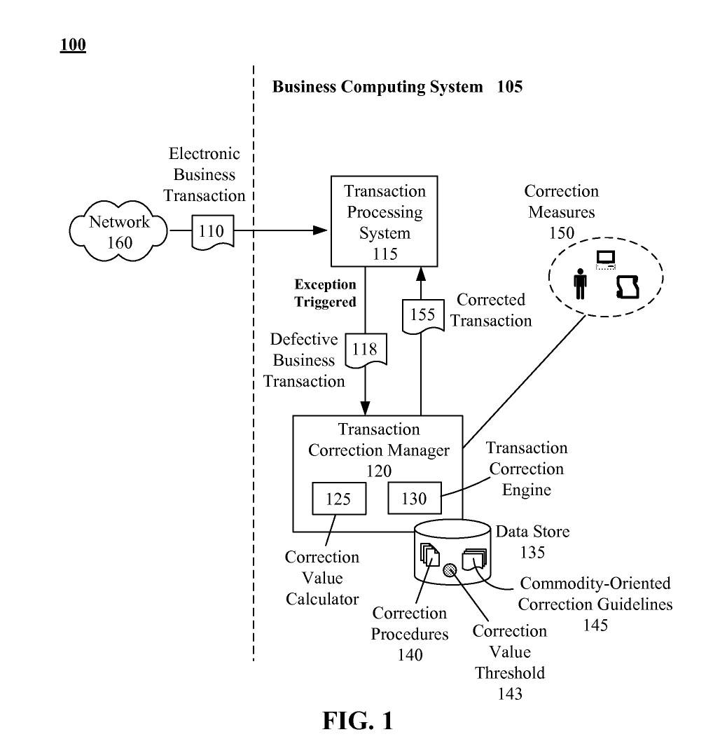

FIG. 1 is a schematic diagram illustrating a system 100 for correcting a defective electronic business transaction 118 using commodity-oriented correction guidelines 145 in accordance with embodiments of the inventive arrangements disclosed herein. In system 100, a business computing system 105 can receive an electronic business transaction 110 via a network 160.

The electronic business transaction 110, herein referred to as the “business transaction”, can represent a set of electronic data having a specific context and value to the receiving business, such as a purchase order, inventory update, price quote, and the like. The content of the business transaction 110 can be represented using standardized languages and/or protocols usable by the business computing system 105. The data contained within the business transaction 110 can be utilized by the business computing system 105 as part of business operations. For example, the data contained in purchase orders can be extracted to produce customer invoices and packing slips.

The business computing system 105 can be configured to process received business transactions 110 to a predetermined state of completion. For example, the processing of a price quote can be determined as complete when the quote data is generated and sent to the requester. Further, it should be noted that the business computing system 105 can include a multitude of components, and, as such, only those components pertinent to the present invention have been depicted in system 100.

To process received business transactions 110, the business computing system 105 can contain a transaction processing system 115, a transaction correction manager 120, and one or more correction measures 150. The transaction processing system 115 can represent the computing resources dedicated to processing the received business transactions 110. Computing resources that can included in the transaction processing system 115 can include, but are not limited to, Web servers, enterprise servers, enterprise software, database servers, database applications, Web applications, and the like.

During processing, a defect within the business transaction 110 can trigger an exception in the transaction processing system 115. For example, a business transaction 110 written in an extensible markup language (XML) can be malformed or have missing data. When the transaction processing system 115 identifies a defective business transaction 118, the defective business transaction can be routed to the transaction correction manager 130.

The transaction correction manager 130 can represent a software application configured to determine if it makes good business sense to correct the defective business transaction 118. For example, it can be costly to have an employee call clients and manually correct every purchase order problem. A more beneficial solution can be to apply a variety of techniques to correct the defects, using human intervention as a last resort or for high profile clients. The transaction correction manager 120 can be the component of the business computing system 100 capable of applying this knowledge of business objectives to the handling of defective business transactions 118.

The transaction correction manager 120 can operate on a server (not shown) external to, but communicatively linked to the transaction processing system 115. In an alternate embodiment, the transaction correction manager 120 can be an integrated component of the transaction processing system 115.

To determine how to approach the correction of the defective business transaction 118, the transaction correction manager 120 can utilize a correction value calculator 125, a transaction correction engine 130, correction procedures 140, and commodity-oriented correction guidelines 145. The transaction correction engine 130 can be configured to utilize the other components of the transaction correction manager 120 to determine the proper handling of the defective business transaction 118.

In order to quantify the business worth for correcting a defective business transaction 118, the transaction correction engine 130 can utilize the correction value calculator 125. The correction value calculator 125 can represent an algorithm configured to calculate a correction value for a defective business transaction 118 based on the commodity-oriented correction guidelines 145.

The commodity-oriented correction guidelines 145 can represent the rules and/or definitions of business values that different types of defects and/or business transactions 118 have to the overall business. For example, a commodity-oriented correction guideline 145 can express that any defective business transaction 118 containing more than five types of defects is to be automatically rejected.

Each commodity-oriented correction guidelines 145 can contain an associated correction value. The correction value can represent a business-sense rating for the commodity-oriented correction guideline 145. For example, correcting a high-value client's defective purchase order can have a correction value of “10”, meaning it makes good business-sense, whereas attempting to correct a large quantity of defects in a purchase order from a low-value client can have a correction value of “100”, meaning that the expenditure of resources is not as worthwhile for the return value to the business.

It is important to emphasize that the centralization of business objectives in the commodity-oriented correction guidelines 145 provides the ability for changes to be made as necessary and without impacting additional systems. Further, the commodity-oriented correction guidelines 145 allow for the business objectives for handling defective business transactions 118 to be abstracted from the actual correction processes.

Once the correction value calculator 125 determines the correction value for the defective business transaction 118, the transaction correction engine 130 can compare the calculated correction value against a preset correction threshold 143. The correction threshold 143 can represent a limiting value that, when exceeded, correcting the defective business transaction 118 is no longer good business-sense. Multiple correction thresholds 143 can exist within the data store 135, each qualified for different conditions. For example, a specific high-value client can have a correction value threshold of “75”, while a low-value client can have a correction value threshold of “20”.

When it is determined that the defective business transaction 118 is to be corrected, the transaction correction engine 130 can identify one or more correction procedures 140 that can be used to correct the defective business transaction 118. The correction procedures 140 can describe a process for correcting a defective business transaction 118. The correction procedures 140 can be configured to address defects contained in the defective business transaction 118 individually or altogether.

Each correction procedure 140 can reference one or more correction measure 150. Correction measures 150 can represent a physical resource that can be utilized to perform a correction of a defect in the defective business transaction 118. Examples of correction measures 150 can include, but are not limited to, human interaction, an automated script, a batch process, a software application, a database application, and the like. For example, a correction procedure 140 for a high-value client can define the use of human interaction as its correction measure 150.

Once the transaction correction engine 130 finishes the execution of correction procedures 140 upon the defective business transaction 118, the transaction correction manager 120 can send the corrected business transaction 155 back to the transaction processing system 115. The transaction processing system 115 can treat the corrected business transaction 155 as a new business transaction 110, restarting its processing, or the transaction processing system 115 can reintroduce the corrected business transaction 155 where it left the process. Any additional defects found during the processing of the corrected business transaction 155 can repeat the correction process conducted by the transaction correction manager 120.

Network 160 can include any hardware/software/and firmware necessary to convey data encoded within carrier waves. Data can be contained within analog or digital signals and conveyed though data or voice channels. Network 160 can include local components and data pathways necessary for communications to be exchanged among computing device components and between integrated device components and peripheral devices. Network 160 can also include network equipment, such as routers, data lines, hubs, and intermediary servers which together form a data network, such as the Internet. Network 160 can also include circuit-based communication components and mobile communication components, such as telephony switches, modems, cellular communication towers, and the like. Network 160 can include line based and/or wireless communication pathways.

As used herein, presented data store 135 can be a physical or virtual storage space configured to store digital information. Data store 135 can be physically implemented within any type of hardware including, but not limited to, a magnetic disk, an optical disk, a semiconductor memory, a digitally encoded plastic memory, a holographic memory, or any other recording medium. The data store 135 can be a stand-alone storage unit as well as a storage unit formed from a plurality of physical devices. Additionally, information can be stored within data store 135 in a variety of manners. For example, information can be stored within a database structure or can be stored within one or more files of a file storage system, where each file may or may not be indexed for information searching purposes. Further, data store 135 can utilize one or more encryption mechanisms to protect stored information from unauthorized access.

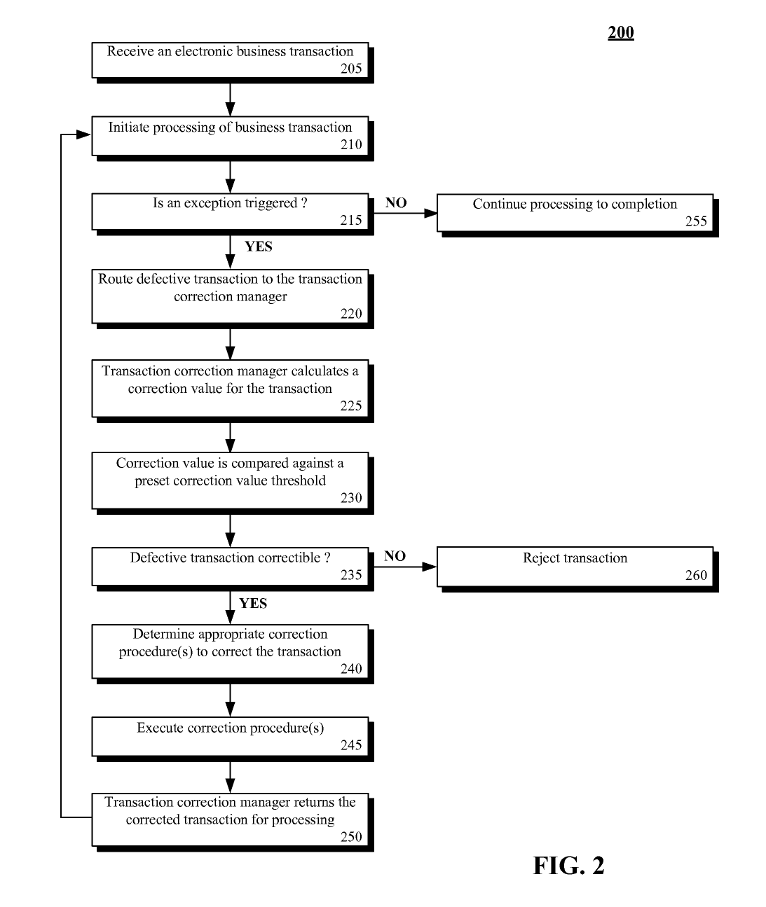

FIG. 2 is a flow chart of a method 200 describing the use of commodity-oriented correction guidelines for correcting defective business transactions in accordance with an embodiment of the inventive arrangements disclosed herein. Method 200 can be performed in the context of system 100 or any other system that utilizes commodity-oriented correction guidelines to correct defective business transactions.

Method 200 can begin with step 205 where an electronic business transaction can be received. Processing of the business transaction can be initiated in step 210. In step 215, it can be determined if the received business transaction has triggered an exception during processing.

When an exception is not triggered, step 255 can execute where the processing of the transaction is continued to completion. It should be noted that the processing of a business transaction can performed in stages and/or by multiple systems and/or subsystems. Therefore, steps 210 and 215 can be reiterated by various systems and/or stages.

When an exception is triggered, flow can proceed to step 220 where the defective transaction can be routed to the transaction correction manager. In step 225, the transaction correction manager can calculate a correction value for the defective business transaction. The correction value calculated in step 225 can be compared against a preset correction value threshold in step 230.

In step 235, it can be determined if the defective business transaction is correctible, based on the result of step 230. When the defective business transaction is not correctible, step 260 can be executed where the business transaction is rejected. When the defective business transaction is determined to be correctible, flow can proceed to step 240 where the appropriate correction procedures can be determined for the transaction.

The correction procedures determined in step 240 can be executed in step 245. In step 250, the transaction correction manager can return the corrected business transaction for further processing. The flow of method 200 can then return to step 210 where the steps of method 200 are repeated until the business transaction is processed to completion or rejected.

The diagrams in FIGS. 1-2 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for correcting defective electronic business transactions using a commodity-oriented approach comprising:
receiving a defective electronic business transaction from an automated processing system;
calculating a correction value for the defective transaction;
comparing the calculated correction value against a preset threshold value; and
correcting the defective electronic business transaction when indicated by the result of the comparing step.

2. The method of claim 1, further comprising:
returning the corrected electronic business transaction to the automated processing system.

3. The method of claim 1, wherein the correcting step further comprises:
identifying at least one correction procedure necessary to correct the defective electronic business transaction; and
executing said at least one correction procedure.

4. The method of claim 1, further comprising:
determining an ability for the defective electronic business transaction to be corrected; and
when the result of the determining step indicates an inability to be corrected, rejecting the defective electronic business transaction.

5. The method of claim 1, wherein the calculating step utilizes a plurality of commodity-oriented correction guidelines configured to quantify business value factors regarding the defective electronic business transaction.

6. The method of claim 4, wherein the business value factors comprise at least one of a cost of required resources, a time sensitivity, a requirement of a business contract, an internal business importance, a transaction context, and a content quantity.

7. The method of claim 1, wherein the correcting step utilizes at least one correction measure comprising at least one of a human interaction, a software application, a software script, a batch process, and an automated service.

8. The method of claim 1, wherein said steps of claim 1 are executed by a transaction correction manager within a service-oriented architecture (SOA).

9. The method of claim 1, wherein said steps of claim 1 are performed by at least one machine in accordance with at least one computer program stored in a computer readable media, said computer programming having a plurality of code sections that are executable by the at least one machine.

10. A system for correcting defective electronic business transactions using a commodity-oriented approach comprising:
a plurality of commodity-oriented correction guidelines configured to quantify business value factors regarding an electronic business transaction, wherein said electronic business transaction contains at least one defect that prevents the electronic business transaction from being processed to a predetermined state of completion by an automated processing system;
a plurality of correction procedures each configured to define at least one correction measure required to correct a defect of the electronic business transaction; and
a transaction correction manager configured to utilize the plurality of commodity-oriented correction guidelines and the plurality of correction procedures to automatically correct the at least one defect of the electronic business transaction, whereby a correction of defects is conducted in accordance with business objectives.

11. The system of claim 10, wherein the transaction correction manager further comprises:
an correction value calculator configured to determine an correction value for the electronic business transaction based upon the plurality of commodity-oriented correction guidelines; and
a transaction correction engine configured to determine and execute at least one correction procedure to correct the at least one defect of the electronic business transaction.

12. The system of claim 11, wherein the transaction correction engine compares the correction value determined by the correction value calculator against at least one preset threshold, wherein said comparison results in at least one of a rejection of the electronic business transaction and an execution of at least one correction procedure.

13. The system of claim 10, wherein the business value factors comprise at least one of a cost of required resources, a time sensitivity, a requirement of a business contract, an internal business importance, a transaction context, and a content quantity.

14. The system of claim 10, wherein the at least one correction measure comprises at least one of a human interaction, a software application, a software script, a batch process, and an automated service.

15. The system of claim 10, wherein the transaction correction manager returns the corrected electronic business transaction to the automated processing system, wherein the corrected electronic business transaction is processed to the predetermined state of completion.

16. The system of claim 10, wherein the transaction correction manager is an integrated component of the automated processing system.

17. The system of claim 10, wherein the components of claim 1 operate in a service-oriented architecture (SOA)

18. A computer program product for correcting defective electronic business transactions in accordance with commodity-oriented correction guidelines, the computer program product comprising:
a computer usable medium having computer usable program code embodied therewith, the computer usable program code comprising:
computer usable program code configured to process defective electronic business transactions received from an automated processing system, to calculate an correction value for the defective electronic business transaction; and
computer usable program code configured to determine at least one correction procedure applicable to the calculated correction value, to execute the at least one correction procedure to correct the defective electronic business transaction.

19. The computer program product of claim 18, further comprising:
computer usable program code configured to ascertain an ability for the defective electronic business transaction to be corrected.

20. The computer program product of claim 18, wherein the computer program product of claim 18 is configured to operate in a service-oriented architecture (SOA).
